(19) United States
(12) Patent Application Publication
(10) Pub. No.: US 2007/0053493 A1
(43) Pub. Date: Mar. 8, 2007

(54) Flat panel x-ray detector

(75) Inventor: Sipke Jacob Bijlsma, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., 5621 BA Eindhoven (NL)

(21) Appl. No.: 10/555,748

(22) PCT Filed: May 5, 2004
(86) PCT No.: PCT/IB04/50600

§ 371 Date: Nov. 4, 2005

(30) Foreign Application Priority Data
May 9, 2003 (EP) 03101298.2

(51) Int. Cl. H05G 1/64; G01T 1/20; G01T 1/24

(52) U.S. Cl. 378/98.8; 250/370.11

(57) ABSTRACT

The invention relates to a flat panel X-ray detector comprising an array of sensor elements (3, 4) for converting X-ray radiation into electrical signals, said sensor elements containing at least one semiconductor diode having at least one sidewall where leakage current can occur, if said detector is connected to a voltage supply. It is an object of the invention to reduce the leakage current. This object is achieved by providing at least one influencing electrode (2, 14) adapted for influencing electric fields at said sidewall (10) for reducing the leakage current.

The invention relates to a flat panel X-ray detector, a method for detecting X-rays and an X-ray apparatus.

Flat panel X-ray detectors are known in the prior art. EP 1 179 852 A2 describes solid state detectors, which can be used for detecting X-rays. Solid state detectors consisting of layers of semi conducting material commonly comprise arrays of photosensor elements with associated switching elements arranged in rows and columns, with the photo sensor elements being addressed by rows of scan lines and columns of data lines. Typically the photosensor elements are photodiodes and the switching elements are thin film field effect transistors (FETs or TFIs) or diodes.

One of several factors that can influence detectors' performance is the amount of leakage current In semi conducting detectors to which the present invention is directed the photodiodes show sidewall leakage from sidewalls of the photodiode with substantial incline to the substrate. Sidewall leakage degrades performance of the detector significantly contributing to detector noise and detector linearity.

It is an object of the present invention to provide a flat panel X-ray detector with reduced leakage current. It is also an object of the present invention to provide a method for detecting X-rays and a corresponding X-ray apparatus in which leakage current is reduced.

The first object is achieved according to the invention by a flat panel X-ray detector comprising an array of sensor elements for converting X-ray radiation into electric signals, said sensor elements containing at least one semiconductor diode having at least one sidewall showing a leakage current, if a voltage is applied, and at least one influencing electrode adapted for influencing an electric field at said sidewall for reducing said leakage current

Usually, sidewalls of semiconductor diodes show leakage current, if a voltage is applied to the diode. Especially said sidewalls are sensitive for electric fields. Changes in electric fields can result in a change of leakage current at the sidewalls. The at least one influencing electrode shields the sidewall against internal or external (parasitic) electric fields and reduces the sensitivity of the sidewall.

Until now it was thought that an external electric field influencing a semiconductor diode sidewall leads automatically to a larger leakage current. Surprisingly it was found out that sidewall leakage of the semiconductor diode can also be reduced by applying an external electric field influencing the sidewall of the diode. The electric field should be strong enough and designed in a way to induce an electric field in said sidewall in order to reduce leakage current.

According to a preferred embodiment of the invention the at least one influencing electrode is connected to a voltage supply. The activated influencing electrode produces an external electric field inducing an electric field at the semiconductor diode sidewall. On the one hand the induced electric field reduces leakage current and on the other hand sensitivity of the leakage current towards changes of internal and/or external electric fields is diminished.

In preferred embodiments of the invention a sensor element comprises a photodiode associated with a switching diode or TFT. In this arrangement of the sensor element leakage current of the switching diode can be reduced as well as leakage current of the photodiode. This results in an extra decrease of leakage current.

The array of sensor elements can be arranged in a sensor layer, which is covered at least partially by at least one insulator layer, preferably SiN, which is cheap commercially available. It has been noticed that detectors with at least one passivation layer covering at least partially the insulation layer and forming an insulation/passivation interface show a considerable increase of leakage current compared to detectors without passivation layer. The passivation layer protects the sensor element from moisture and is a further electric isolation. Besides SiN, stacks of organic materials can be used as passivation material The detector is basically flat and comprises stacked layers, respectively panels.

A possible explanation for the increased leakage current can be that the passivation has the function of a gate insulator and forms a parasitic TFT at the sidewalls. The interface of the operating sensor element can influence an electric field inducing band bending at the sidewalls altering the leakage current. Detectors with insulation and passivation are very common Influencing electrodes reduce leakage current also for this type of detector.

Favourable arrangements and designs of said at least one influencing electrode are defined in further dependent claims.

Especially for flat detectors the influencing electrode can be formed as a top shield electrode on a top side of the passivation layer shielding said sensor layer. The top shield electrode covers nearly the whole top side of the detector shielding the complete sensor layer and influencing each sidewall of each photodiode and switching diode by e.g. capacitive coupling. The top shield electrode can be arranged easily on a flat detector without changing its internal structure. This embodiment of the invention is therefore effective and cheap to produce.

To detect X-rays either photodiodes sensitive for X-rays or photodiodes sensitive for light can be used. The transparency properties of the top shield electrode have to be adjusted respectively.

To detect X-rays with photodiodes sensitive for light a scintillator layer can be arranged over said sensor layer converting X-rays into light destined for said photodiodes. A light transparent top shield electrode can be arranged between the scintillator and the light sensitive photodiode, or an X-ray transparent top shield electrode is arranged on top of the scintillator layer. Different ways to produce X-ray detectors are offered from which the cheapest to produce can be chosen.

In another preferred embodiment of the invention a lateral shield electrode is arranged between said passivation layer and said sensor layer. According to this embodiment the influencing electrode is an integral part of the detector and not visible from the outside. The influencing electrode is protected. In this embodiment the electric field at the sidewall is influenced e.g. by forming an electric field parallel to the insulation/passivation interface.

To affect each sensor element, especially effectively the at least one influencing electrode is arranged on a bottom side of said sensor layer between a switching diode and a photodiode.

The invention can be applied for detectors containing photodiodes having a first semiconductor layer containing n-doped amorphous silicon and a second semiconductor layer containing intrinsic amorphous silicon and a third semiconductor layer containing p-doped amorphous silicon. Basically, the semi-conducting layers of the diode and the detector layers are directed equally.

The electric field is spanned between the influencing electrode and a counter electrode. A single counter electrode can be provided, or a diode electrode can take on the function of the counter electrode. The sensor elements, especially the semiconductor photodiodes, can be arranged on a metal layer. This metal layer can operate as counter electrode.

The object of the invention is also achieved by a method for detecting X-rays comprising the steps of: applying a reverse bias to an array of sensor elements for converting X-ray radiation into electrical signals, said sensor elements containing at least one semiconductor diode having at least one sidewall showing a leakage current, applying a voltage to at least one influencing electrode producing an electric field, wherein said sidewall is arranged to influence an electric field at said sidewall for reducing said leakage current and exposing the detector to an X-ray radiation.

Preferably, X-ray radiation is converted by a scintillator into light, which is directed to said sensor elements.

The object is further achieved by an X-ray apparatus comprising at least one flat panel X-ray detector.

The invention will now be described by way of an example with reference to the drawings, in which:

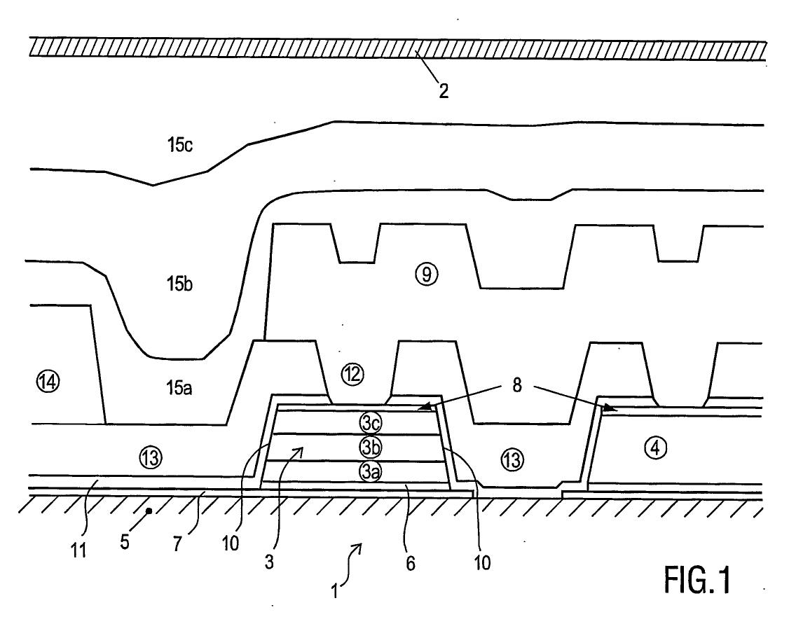

FIG. 1 shows a cross sectional view of a part of an X-ray detector according to the invention,

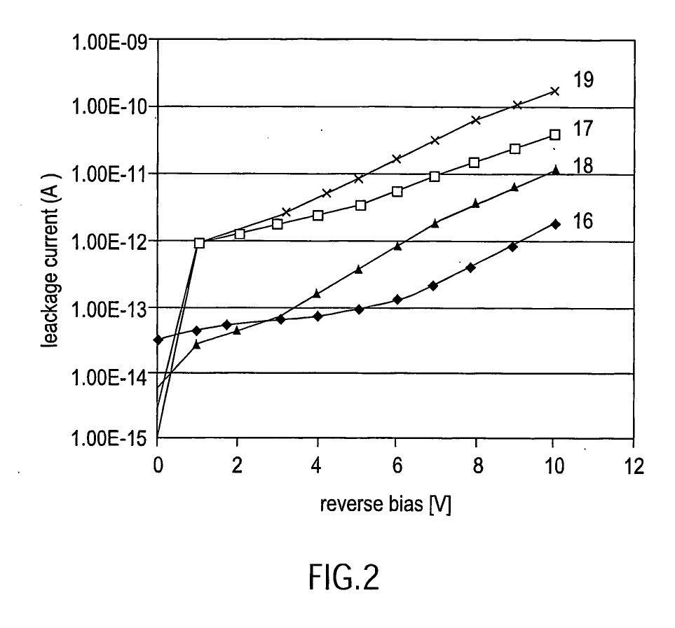

FIG. 2 shows a graphical representation of measurements of leakage current of a sensor elements with and without passivation,

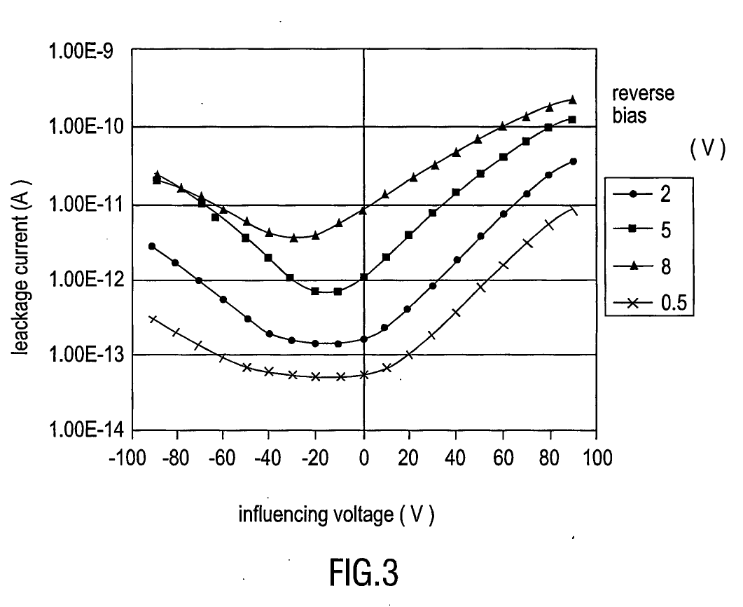

FIG. 3 shows a graphical representation of measurements of leakage current as a function of influencing electrode voltage, and

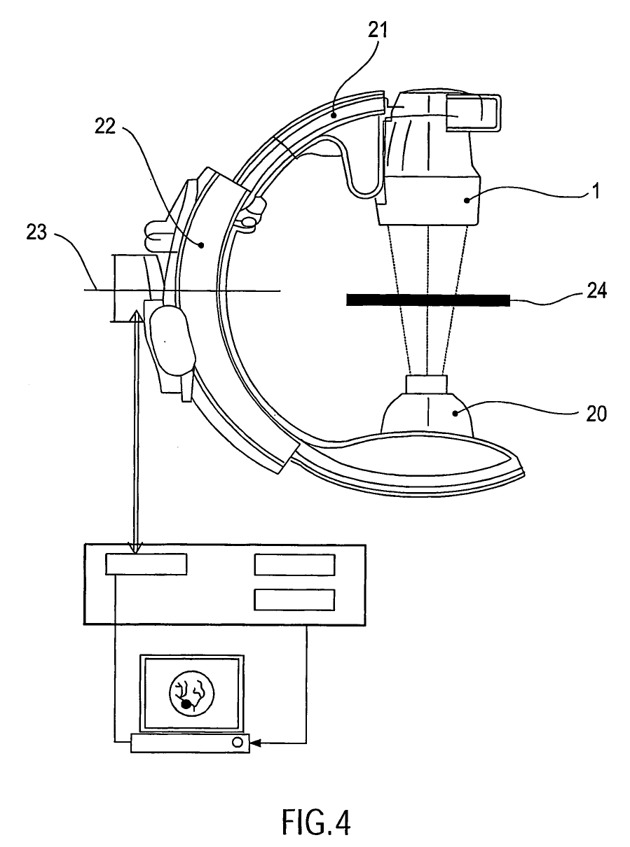

FIG. 4 shows an X-ray examination apparatus according to the invention.

FIG. 1 shows a flat panel X-ray detector 1 according to the invention detecting visible light. The X-ray detector contains a scintillator layer (not shown) converting X-ray into visible light arranged on top of the top influencing electrode 2. The detector 1 further contains an array of sensor elements each containing a photodiode 3 and a switching diode 4. As known from the state of the art the sensor elements are arranged in rows and columns. The array is electrically coupled to a read-out circuit (not shown) by said switching diodes 4. The read-out circuit is situated off a substrate layer 5 amplifying and processing the electrical signals generated by the array. The photodiodes 3 are designed for detecting visible radiation, typically green light. A suitable scintillator is CsI:T1 which has a high conversion efficiency of X-ray into green light

The sensor elements 3, 4 contain stacked semiconductor layers. A number of processes exist in the art by which semi-conducting sensor element arrays can be fabricated. They will not be described here. The sensor elements 3, 4 form a sensor layer and they are disposed on the substrate layer 5. The sensor elements 3, 4 are arranged in an array containing e.g. one hundred switching diodes 4.

In the following the construction of a photodiode is described in more detail. Each photodiode 3 contains a bottom diode electrode 6 consisting of a barrier metal. The bottom diode electrode 6 is connected to a connection layer 7 in which the column lines are formed. The connection layer 7 is located adjacent to the substrate layer 5 detector inwards. Opposite to the substrate layer 5 the semiconductor layers making up the photodiode island are situated on the bottom diode electrode 6.

In FIG. 1 a NIP diode stack is shown. The NIP diode stack consists of three semi-conducting layers. A n-doped amorphous silicon layer 3a overlays the barrier metal, it is followed detector inwards by an intrinsic amorphous silicon layer 3b and a n-doped amorphous silicon layer 3c. The p-doped amorphous silicon layer 3c is covered by a top diode electrode 8 consisting of transparent ITO (indium tin oxide). The top diode electrode 8 connects the photodiode 3 to another connection layer 9 made from aluminium (Al) in which row lines are formed. The edges of n-doped 3a, the intrinsic 3b and the p-doped silicon layer 3c form diode sidewalls 10 nearly perpendicular to the substrate layer 5 and the connection layer 7. The sidewalls 10 are open and unprotected. The sidewalls 10 can cause a sidewall leakage.

Opposite to the substrate layer 5 the column line and the NIP diode are covered by a barrier layer 11. Only a conical connection 12 between the top diode electrode 8 and the row line 9 is omitted from the barrier layer. Detector inwards the barrier layer 11 is overlaid by an insulator layer 13 consisting of SiN.

The top diode electrodes 8 of the two diodes 3, 4 are connected by the row line 9. According to the invention opposite to the switching diode 4 an inner influencing electrode 14 is situated next to the photodiode 3 on the insulator layer 13. An adjustable influencing voltage can be applied between the column line 7 and the inner influencing electrode 14. The influencing voltage is adjustable between −100 and +100 V. The electric field caused by the voltage affects especially diode sidewalls 10 adjacent to the inner influencing electrode 14.

The insulator layer 13, the row line 9 and the inner influencing electrode 14 are protected by a laminate of three passivation layers 15a, 15b, 15c each containing epoxide resin. According to the invention the most outside passivation layer 15c is coated by the top influencing electrode 2. The detector 1 has a flat and plane structure, and the top influencing electrode 2 shields one side of the detector completely. Also between the bottom diode electrode 6 and the top electrode 2 an adjustable influencing voltage between −100 and +100 volt can be applied. The electric field caused by the top influencing electrode 2 goes across the whole detector construction and is therefore influencing all diode sidewalls of the senor layer and interfaces of the layers 13, 15. The electric fields caused by the influencing electrodes influence the electric field distribution in the sidewalls 10 and reduce sidewall leakage.

FIG. 2 shows the leakage current as a function of the reverse bias. No influencing voltage is applied. To make the detector operate, a reverse bias is applied to the top diode electrode 8 and the bottom diode electrode 6 and the photodiodes are operated in the non-conducting direction. Actually a leakage current occurs because of sidewall leakage.

The line with diamonds 16 shows the leakage current of a switching diode without passivation dependent on the reverse bias. The line with squares 17 refers to a photodiode without passivation.

The two other lines refer to diode structures with passivation layers. The line with triangulars 18 refers to a switching diode and the line with crosses 19 refers to a photodiode.

Especially the photodiodes 3 have a threshold leakage current namely 1,00 E-12 at a reverse bias of approx. 1 V.

A comparison of the leakage current of diodes with 18, 19 and without passivation 16, 17 show that there is an extra leakage current 18, 19 related to the passivation. This extra leakage current cannot be explained by lateral conduction. Significant lateral currents are not measured. Also the threshold and exponential properties of the leakage current suggest rather a semi conducting mechanism. A possible mechanism for explanation is band bending on the exposed diode sidewalls 10 induced by an electric field. Such a mechanism can be visualized as a parasitic TFT (thin field transistor) being formed on the diode sidewalls with the passivation 15a, 15b, 15c as gate insulator.

The measurements shown in FIG. 3 have been carried out on an array of 100 switching diodes top-coated with a laminate of organic materials as passivation layer 15a, 15b, 15c. The measurement was carried out at 60° C. Wait time before the measurement start was 120 sec and the wait time between individual measurements was 60 sec. Conducting material was applied on top of the array as top influencing electrode 2 covering almost the whole array. The influencing voltage was adjusted between −90 and 90 V. The leakage current was measured by scratching probe needles through the passivation layers 15a, 15b,15c.

The leakage current was measured for four different reverse bias for different influencing voltages. All four measurement sequences show an optimum leakage current at influencing voltages of around −20 V. For each reverse bias the leakage current without influencing voltage is higher compared to applying an influencing voltage. At a reverse bias of 5V the leakage current is about 7E-13 A. Without passivation the leakage current is about 5E-13 A.

The leakage current is very sensitive for changes in the electric field close to the sidewalls. It was also measured that changes of the voltage at the insulator/passivation (SiN/epoxy) interface 13/15a of 0.4 V can double the leakage current. Bias changes can be caused by contamination of the interface or by contamination of the layer itself. Also marginal conduction between the connection layer 9 and the diode top electrode 8 can cause leakage current.

The X-ray examination apparatus shown in FIG. 4 uses the X-ray detector 1 according to the invention. The X-ray detector 1 and a X-ray source 20 are suspended from a C-arm 21. The C-arm 21 is movable through a sleeve 22 and rotatable around an horizontal axis 23. A patient table 24 is located between the X-ray source 20 and the X-ray detector 1. A patient (not shown) to be examined lays on the patient table 24.

The invention provides flat panel X-ray detectors 1 fulfilling high quality standards. The described detectors 1 have semiconductor diodes 3,4 which show unwanted sidewall leakage current when a reverse bias is applied thereon. According to the invention the leakage current is reduced by applying an electric field on said sidewalls. Such an electric field is produced by an influencing electrode, their position and design within the detector is not determined completely but can be chosen adjusted to the given circumstances.

1. Flat panel X-ray detector comprising:
an array of sensor elements for converting X-ray radiation into electric signals, said sensor elements containing at least one semiconductor diode (3, 4) having at least one sidewall (10) showing a leakage current, if a voltage is applied,
and at least one influencing electrode (2,14) adapted for influencing an electric field at said sidewall (10) for reducing said leakage current.

2. Flat panel X-ray detector as claimed in claim 1, characterized in that said influencing electrode (2, 14) is connected to a voltage supply.

3. Flat panel X-ray detector as claimed in claim 1, characterized in that said at least one semiconductor diode comprises a photodiode (3) and/or a switching diode (4).

4. Flat panel X-ray detector as claimed in claim 1, characterized in that said array of sensor elements (3, 4) is arranged in a sensor layer and said sensor layer is covered at least partially by at least one insulation layer (13), which is covered at least partially by at least one passivation layer (15a, 15b, 15c).

5. Flat panel X-ray detector as claimed in claim 4, characterized in that at least one of said influencing electrodes is formed as a top shield electrode (2) on a top side of the passivation layer (15a, 15b, 15c) shielding said sensor layer.

6. Flat panel X-ray detector as claimed in claim 5, characterized in that said top shield electrode (2) is transparent for light.

7. Flat panel X-ray detector as claimed in claim 5, characterized in that a scintillator layer is arranged between said top shield electrode and said top side of said passivation layer.

8. Flat panel X-ray detector as claimed in claim 4, characterized in that said influencing electrode (14) is formed as a lateral shield electrode arranged between said passivation layer (15a, 15b, 15c) and said sensor layer.

9. Flat panel X-ray detector as claimed in claim 4, characterized in that said at least one influencing electrode (14) is arranged on a bottom side of said sensor layer between a switching diode (3) and a photodiode (4).

10. Flat panel X-ray detector as claimed in claim 1, characterized in that said photodiode (3) has stacked semiconductor layers (3a, 3b, 3c) and edges of the semiconductor layers form said sidewall (10).

11. Flat panel X-ray detector as claimed in claim 10, characterized in that said photodiode (3) has a first semiconductor layer containing n-doped amorphous silicon (3a) and a second semiconductor layer containing intrinsic amorphous silicon (3b) and a third semiconductor layer containing p-doped amorphous silicon (3c).

12. Method for detecting X-rays comprising the steps of:
applying a reverse bias to an array of sensor elements for converting X-ray radiation into electrical signals, said sensor elements containing at least one semiconductor diode (3, 4) having at least one sidewall (10) showing a leakage current,
applying a voltage to at least one influencing electrode (2, 14) producing an electric field, wherein said sidewall (10) is arranged to influence an electric field at said sidewall (10) for reducing said leakage current and
exposing the detector (1) to an X-ray radiation.

13. Method as claimed in claim 12, characterized by forming said sidewall (10) as edges of a first semiconductor layer containing n-doped amorphous silicon (3a) and a second semiconductor layer containing intrinsic amorphous silicon (3b) and a third semiconductor layer containing p-doped amorphous silicon (3c).

14. Method as claimed in claim 12, characterized by converting X-ray radiation into light and directing said sensor elements to said light.

15. X-ray apparatus comprising an X-ray source and at least one flat panel X-ray detector as claimed in claim 1.
